(19) United States
(12) Patent Application Publication
(10) Pub. No.: US 2007/0268214 A1
(43) Pub. Date: Nov. 22, 2007

(54) Method and apparatus for driving plasma display panel

(75) Inventor: Youngham Lee, Suwon-si (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/798,870

(22) Filed: May 17, 2007

(30) Foreign Application Priority Data
May 19, 2006 (KR) 10-2006-0044950

(51) Int. Cl. G09G 3/28

(52) U.S. Cl. 345/60

(57) ABSTRACT

A method and apparatus for driving a plasma display panel (PDP) is disclosed to reduce noise generated during a discharge sustain period, wherein a timing signal generator includes a first random timing signal generator and a second random timing signal generator, and wherein the first random timing signal generator generates randomly changes a cycle of a scan timing signal for a scan driver to generate a discharge sustain voltage, and the second random timing signal generator randomly changes a cycle of a sustain timing signal for a sustain driver to generate a discharge sustain voltage, and whereby a cycle of the discharge sustain voltage is variably generated in response to the scan timing signal and the sustain timing signal where cycles are randomly varied.

### CROSS-REFERENCE TO RELATED APPLICATION

The present application is based on, and claims priority from, Korean Application Number 10-2006-0044950, filed May 19, 2006, the disclosure of which is incorporated by reference herein in its entirety.

### BACKGROUND

The following description relates generally to a method and apparatus for driving a plasma display panel (PDP).

There is much demand for a display apparatus capable of expressing near-natural colors with a high resolution and a large size as multimedia era is ushered in. PDPs have come into the spotlight as substitutes for conventional CRTs (cathode ray tubes) in large displays to meet the demand.

PDPs can be classified as a DC type PDP and an AC type PDP according to the voltage signal used for driving electrodes. The AC type PDPs are superior in a number of respects including reliability and image quality. The AC type PDP is therefore the main stream in the current display field.

In driving a PDP, a driving voltage is sequentially applied to scan electrodes in the first place, and image data is supplied to address electrodes. A start (starting) discharge is generated in cells between the scan electrodes and the address electrodes.

Following generation of the start discharge, a discharge sustain voltage is supplied to the scan electrodes and sustain electrodes. Then, a sustain discharge is generated in between the scan electrodes and sustain electrodes of cells where the start discharge has been generated to cause the cells to generate light for a predetermined time.

As a result, an electromagnetic field is generated in the cells where sustain discharge has been generated by the discharge between the scan electrodes and the sustain electrodes, and a minuscule amount of electrons is accelerated in discharge gas filled in the PDP by the generated electromagnetic field. The accelerated electrons and neutral particles in the discharge gas collide to be ionized to electrons and ions. The collision between the ionized electrons and neutral particles causes the neutral particles to be ionized to electrons and ions more quickly, whereby the discharged gas is changed to a plasmic state to generate ultraviolet light. The generated ultraviolet light excites phosphor to generate visible light, and the generated visible light is emitted to outside via a front surface of a substrate, enabling to recognize the generation of light of a relevant cell.

A general AC type PDP includes a front substrate and a rear substrate facing each other, and the front and rear substrates are bonded by a low melting point glass bonding member. Thereafter, the air in discharge cells of the bonded PDP is evacuated and discharge gases are injected into the discharge cells under a condition of approximately 400˜500 Torr to manufacture a resultant PDP.

There are locally generated portions inside the bonded PDP where a protection film formed underneath the front substrate and a barrier rib formed on the rear substrate are not tightly sealed. The portions generate gaps between the protection film and the barrier rib.

When a driving voltage is applied to sustain electrodes, scan electrodes and address electrodes in order to drive the PDP, suction force is generated in between the sustain electrodes, scan electrodes and address electrodes. In other words, the suction force may be generated from the gaps where the protection film of the front substrate and the barrier rib of the rear substrate are not hermetically sealed. Under this circumstance, if a driving voltage is applied to generate a suction force, the gap may be adhered by the suction force, and if the voltage is not supplied, the suction force disappears to cause the gap to open. This phenomenon of the gap being adhered and widened may be repeated as the voltage is applied or not applied thereto.

This phenomenon explains that there is generated a resonance between the front substrate and the rear substrate, and becomes a source of generating noise in the PDP.

### SUMMARY

An object of this disclosure is to provide a method and apparatus for driving a plasma display panel (PDP) configured to alleviate a peak element of noise caused by resonance generated between a front substrate and a rear substrate, thereby reducing the generation of noise.

According to the present disclosure, a period of discharge sustain voltage applied to scan electrodes and sustain electrodes is randomly varied within a predetermined time scope during a discharge sustain period, whereby a peak value of resonance generated during the discharge sustain period can be alleviated to reduce generation of noise.

To this end, a timing signal generator for generating a timing signal for driving the PDP includes first and second random timing signal generators.

The first random timing signal generator randomly varies a period of a scan timing signal for a scan driver to generate a discharge sustain voltage during the discharge sustain period.

The second random timing signal generator randomly varies a period of a sustain timing signal for a sustain driver to generate a discharge sustain voltage during the discharge sustain period.

In one general aspect, a method for driving a plasma display panel (PDP) comprises: applying a driving voltage to scan electrodes during an initialization period to initialize cells; applying a driving voltage to scan electrodes during address period and applying image data to address electrodes to generate a start discharge to the initialized cells; and applying a cycle-randomly-varied discharge sustain voltage to the scan electrodes and sustain electrodes during a discharge sustain period to sustain discharges of cells where the start discharge has been generated.

In another general aspect, an apparatus for driving a plasma display panel (PDP) comprises: a timing signal generator for generating a scan timing signal, a sustain timing signal and an address timing signal in response to control of a processor; a scan driver for generating a driving voltage in response to the scan timing signal and applying the driving voltage to scan electrodes; a sustain driver for generating a driving voltage in response to the sustain timing signal and applying the driving voltage to sustain electrodes; and an address driver for applying image data to address electrodes in response to the address timing signal, wherein the timing signal generator comprises: a first random timing signal generator for randomly varying a generation cycle of the scan timing signal during discharge sustain period; and a second random timing signal generator for randomly varying a generation cycle of the sustain timing signal during the discharge sustain period.

### BRIEF DESCRIPTION OF THE DRAWINGS

This disclosure is illustrated by way of exemplary implementations and not limitation in the figures of the accompanying drawings, in which, wherever possible, the same reference numerals will be used throughout the drawings to refer to the same or like parts.

FIG. 1 is a schematic view illustrating a structure of a plasma display panel (PDP).

FIG. 2 is a schematic block diagram illustrating configuration of an apparatus for driving a PDP.

FIG. 3 shows a method for dividing one field using an intra-field time division gradation display technique expressing 256 gradations.

FIGS. 4a to 4c are drawings of waveforms of driving voltage applied respectively to scan electrodes, sustain electrodes and address electrodes during a single subfield period.

FIG. 5 is a drawing of waveform of discharge sustain voltage applied to scan electrodes and sustain electrodes during a discharge sustain period.

FIG. 6 is a drawing for an exemplary implementation of a waveform of a discharge sustain voltage applied to scan electrodes and sustain electrodes during a discharge sustain period.

FIG. 7 is a drawing for another exemplary implementation of a waveform of a discharge sustain voltage applied to scan electrodes and sustain electrodes during a discharge sustain period.

FIG. 8 is a drawing for still another exemplary implementation of a waveform of a discharge sustain voltage applied to scan electrodes and sustain electrodes during a discharge sustain period.

### DETAILED DESCRIPTION

The described implementations serve only for explanation and are not limiting. The matters exemplified in this description are provided to assist in a comprehensive understanding of certain exemplary implementations disclosed with reference to the accompanying drawings. Accordingly, those of ordinary skill in the art will recognize that various changes and modifications of the exemplary implementations described herein can be made without departing from the scope and spirit of the appended claims. This application therefore serves to explain its general principles and concepts in most useful and easiest fashions. As used in this specification and the appended claims, the singular forms “a”, “an”, and “the” include plural references unless the content clearly dictates otherwise.

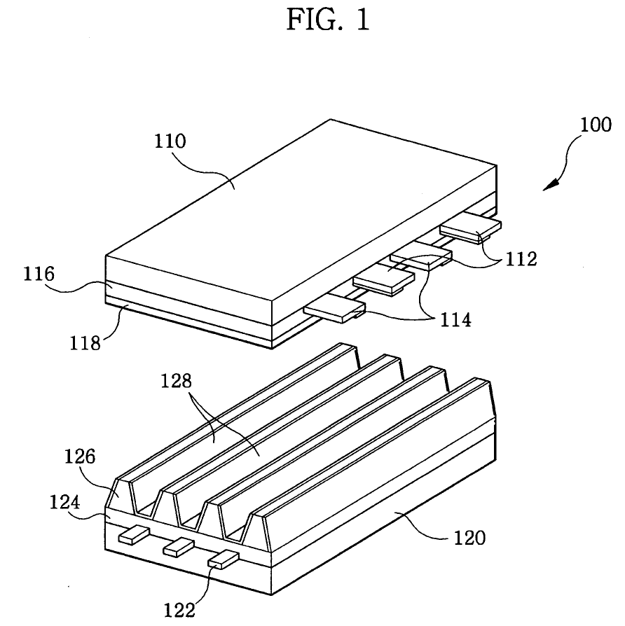

FIG. 1 is a schematic view illustrating a structure of a plasma display panel (PDP).

As represented in FIG. 1, a general AC type PDP 100 includes a front substrate 110 and a rear substrate 120 each substrate facing and bonded each other.

The front substrate 110 is formed thereunder with a plurality of scan electrodes 112 and a plurality of sustain electrodes 114, each electrode arranged in parallel and alternation, and a dielectric layer 116 is formed to wrap the plurality of scan electrodes 112 and the plurality of sustain electrodes 114. The dielectric layer 116 is formed thereunder with a protection layer 118.

The rear substrate 120 is formed thereon with a plurality of address electrodes 122 in an orthogonal direction with the scan electrodes 112 and the sustain electrodes 114, and a dielectric layer 124 is formed to wrap the plurality of address electrodes 122. On top of the dielectric layer 124 between the plurality of address electrodes 122 there are formed barrier ribs 126, and phosphor layers 128 are coated on grooves formed by the barrier ribs 126 with the phosphor layers 128 of red (R), green (G) and blue (B) phosphors that emit visible light to display images during the address discharge, and these phosphor layers are respectively divided per groove formed by the barrier ribs 126.

The front and rear substrates 110 and 120 are bonded by a glass bonding member of low melting point. Thereafter, the air in discharge cells of the bonded PDP is evacuated and discharge gases such as Ne, He, and Ne+He and an inert gas comprising a small amount of xenon fill each cell under a condition of approximately 400˜500 Torr to manufacture a resultant PDP.

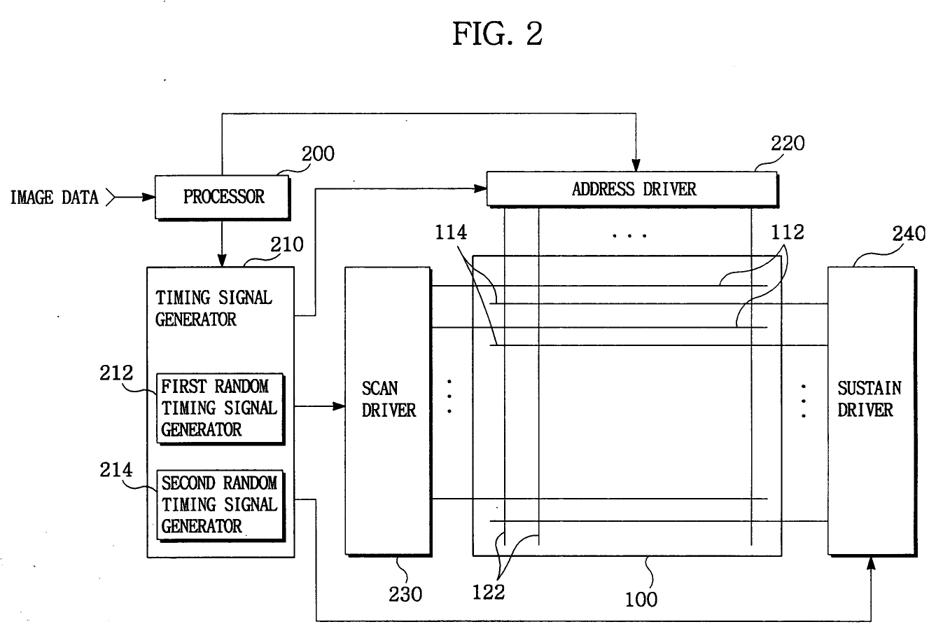

Referring to FIG. 2 which is a schematic block diagram illustrating configuration of an apparatus for driving a PDP, reference numeral 200 defines a processor. The processor 200 controls an overall operation of displaying inputted image data on the PDP 100.

Reference numeral 210 of a timing signal generator generates a scan timing signal for supplying a driving voltage to the scan electrodes 112 responsive to control of the processor 200, a sustain timing signal for supplying a driving voltage to the sustain electrodes 114 and an address timing signal for outputting data to the address electrodes 122.

The timing signal generator 210 includes therein a first random timing signal generator 212 and a second random timing signal generator 214. The first random timing signal generator 212 randomly and variably generates within a predetermined scope of time a timing signal for supplying a discharge sustain voltage to the scan electrodes 112 during a discharge sustain period for driving the PDP 100. The second random timing signal generator 214 randomly and variably generates within a predetermined scope of time a sustain timing signal for supplying a discharge sustain voltage to the sustain electrodes 114 during a discharge sustain period for driving the PDP 100.

Reference numeral 220 defines an address driver. The address driver 220 outputs in parallel image data provided by the processor 200 to the plurality of address electrodes 122 of the PDP 100 in response to an address timing signal generated by the timing signal generator 210.

Reference numeral 230 of a scan driver generates a driving voltage in response to a scan timing signal generated by the timing signal generator 210 and supplies the voltage to the plurality of scan electrodes 112 of the PDP 100.

Reference numeral 240 of sustain driver generates a driving voltage in response to a sustain timing signal generated by the timing signal generator 210 and supplies the voltage to the sustain electrodes 114 of the PDP 100.

In the apparatus thus described for driving the PDP, the inputted image data is processed by the processor 200 and is outputted to the address driver 220. The processor 200 controls the timing signal generator 210 to generate a timing signal for supplying a driving voltage to the plurality of scan electrodes 112, the plurality of sustain electrodes 114 and the plurality of address electrodes 122.

Successively, the timing signal generator 210 respectively generates a scan timing signal, a sustain timing signal and an address timing signal responsive to the control of the processor 200. The address driver 220, the scan driver 230 and the sustain driver 240 generate a driving voltage in response to the generated timing signals. The generated driving voltage is supplied to the address electrodes 122, the scan electrodes 112 and the sustain electrodes 114 of the PDP 100 to allow the PDP 100 to display images of the image data.

At this time, the timing signal generator 210 generates scan timing signals and sustain timing signals in which the first random timing signal generator 212 and the second random timing signal generator 214 are randomly changed within a predetermined time during sustain period. Discharge sustain voltages are generated in which the scan driver 230 and the sustain driver 240 are randomly varied responsive to the randomly-varied scan timing signals and sustain timing signals to thereby drive the scan electrodes 112 and the sustain electrodes 114.

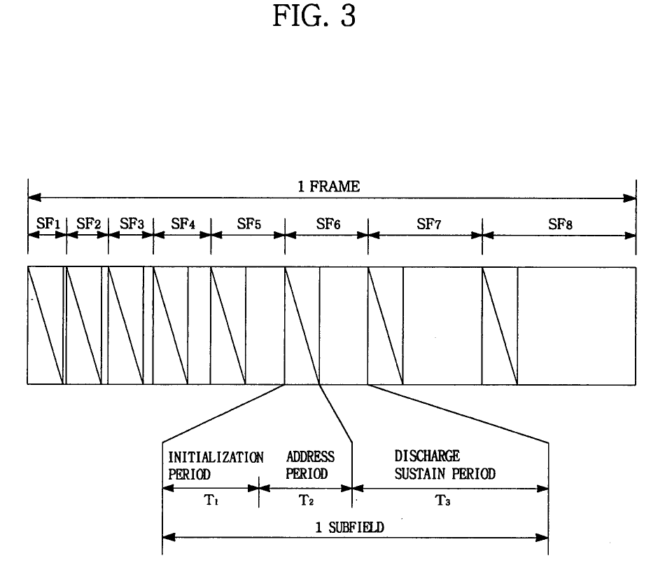

The PDP 10 is driven basically using the intra-field time-division gradation display technique (ADS method; Address Display period Separated sub-field method). FIG. 3 shows a method for dividing one field using the intra-field time division gradation display technique expressing 256 gradations. In the case of FIG. 3, one field is composed of eight subfields. Ratios of the sustain periods in the eight subfields are respectively set at 1, 2, 4, 8, 16, 32, 64, and 128. By combinations of these 8-bit binary numbers, 256 gradations can be expressed. For NTSC (National Television System Committee) televisions, an image per second is composed of 60 fields, and therefore, one filed has 16.7 ms.

A single (TV) frame constitutes a plurality (eight) of subfields (SF₁˜SF₈). For example, when an image is displayed in a total of 256 gradations (level 0 gradation to level 255 gradation), one frame is divided to eight subfields, and each of the eight subfields (SF₁˜SF₈) is displayed with images on the PDP 100. The displayed images of gradations are time-integrated on the eyes of the observer.

At this time, each subfield (SF₁˜SF₈) typically displays images on the PDP 100 using the ADS method. The ADS method divides each subfield (SF₁˜SF₈) period to an initialization period (T₁), an address period (T₂) and a discharge sustain period (T₃). A pulse voltage is applied to the entire plurality of scan electrodes 112 during the initialization period (T₁).

The driving voltage is sequentially applied to the plurality of scan electrodes 112 during the address period (T₂) and image data is applied to the sequentially driving voltage-applied scan electrodes 112 and simultaneously to the plurality of address electrodes 122. Thereafter, the start discharge is generated among the plurality of cells interposed between the plurality of scan electrodes 112 and the plurality of address electrodes 122 in response to the image data.

The discharge sustain voltage is applied to the scan electrodes 112 and the sustain electrodes 114 during the discharge sustain period (T₃) to allow the start discharge generated from each cell to stay for a predetermined period.

The initialization period (T₁) and the address period (T₂) of the subfields (SF₁˜SF₈) are the same. However, the discharge sustain period (T₃) is differently set up for each subfield (SF₁˜SF₈). For example, Ratios of each of the eight subfields (SF₁˜SF₈) are assigned, in ascending order, binary weights such as 1, 2, 4, 8, 16, 32, 64 and 128. The discharge sustain period (T₃) is differently set up according to the eight subfields (SF₁˜SF₈), such that the PDP 100 is displayed with 256 gradations.

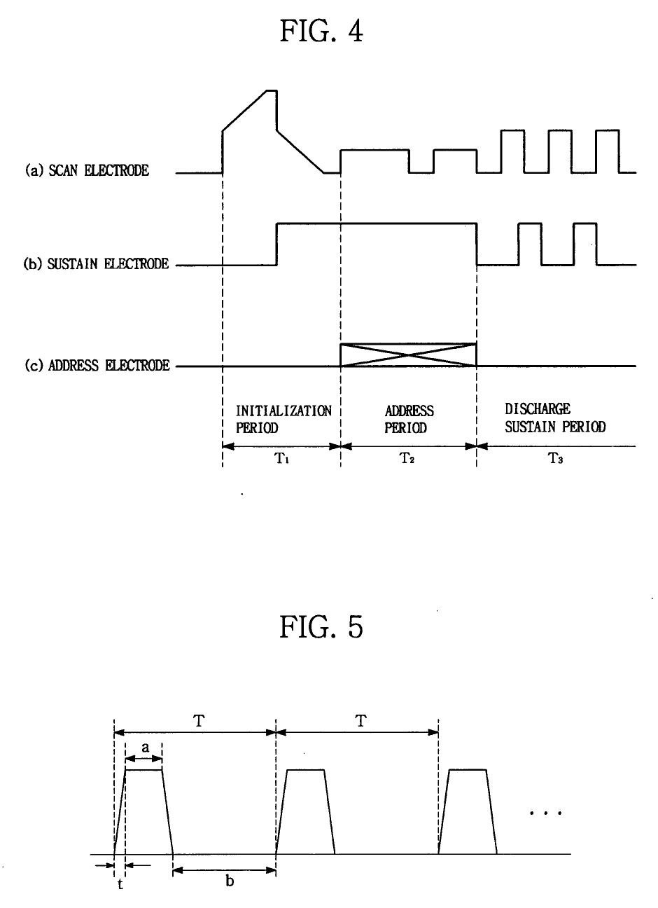

FIGS. 4a to 4c are drawings of waveforms of driving voltage respectively applied to scan electrodes, sustain electrodes and address electrodes during a single subfield period. An initialization pulse voltage is applied to the entire plurality of scan electrodes 112 during the initialization period (T₁) to accumulate wall charges, and state of all the cells is initialized.

A scan pulse voltage is sequentially applied to the plurality of scan electrodes 112 during the address period (T₂), and image data is applied to the address electrodes 122. Then, a start discharge is generated from among the cells between the scan electrodes 112 and the address electrodes 122 according to the image data to accumulate wall charges, and an image of one frame is started.

The discharge sustain voltage is applied to the scan electrodes 112 and the sustain electrodes 114 during the discharge sustain period (T₃). The discharge sustain voltage is e.g., a pulse voltage. The cells where the wall charges are accumulated maintain the discharged state according to the application of the discharge sustain voltage. In other words, the cells where the charges are generated are added by the wall charges and the discharge sustain voltage during the address period (T₂) to continue the discharges. The continuation of discharge is maintained during the discharge sustain period (T₃).

FIG. 5 is a drawing of waveforms of the discharge sustain voltage applied to the scan electrodes 112 and the sustain electrodes 114 during the discharge sustain period (T₃). The discharge sustain voltage applied to the scan electrodes 112 and the sustain electrodes 114 during the discharge sustain period (T₃) is a pulse voltage having a predetermined cycle (T), e.g., a cycle (T) of approximately 5 μs.

The discharge sustain voltage applied to the scan electrodes 112 and the sustain electrodes 114 is not a full rectangular wave, but actually has ramps at a rising edge and a falling edge. An interval between the rising edge and the falling edge is about 250 ns.

A rising edge voltage maintaining interval (Ta) that rises and maintains during the rising edge and a falling edge voltage maintaining interval (Tb) that falls and maintains during the falling edge respectively have the same value in the discharge sustain voltage applied to the scan electrodes 112 and the sustain electrodes 114.

In a case that the rising edge voltage maintaining interval (Ta) and the falling edge voltage maintaining interval (Tb) respectively have the same value, the discharge is systematically maintained between the scan electrodes 112 and the sustain electrodes 114, and the maintenance of the systematic discharge creates a mechanical resonance, thereby causing a big noise to be generated at a particular resonance frequency.

In this disclosure, the first random timing signal generator 212 and the second random timing signal generator 214 randomly and variably generate the scan timing signal and the sustain timing signal within a predetermined time range. Then, the scan driver 230 and the sustain driver 240 generates a discharge sustain voltage where the rising edge voltage maintaining interval (Ta) and the falling edge voltage maintaining interval (Tb) are randomly changed according to the variation of the scan timing signal and the sustain timing signal and apply to the scan electrodes 112 and the sustain electrodes 114. As a result, maintenance of the systematic regular discharge is not generated from the PDP 100, and therefore the mechanical resonance can be alleviated to reduce the noise from the particular resonance frequency.

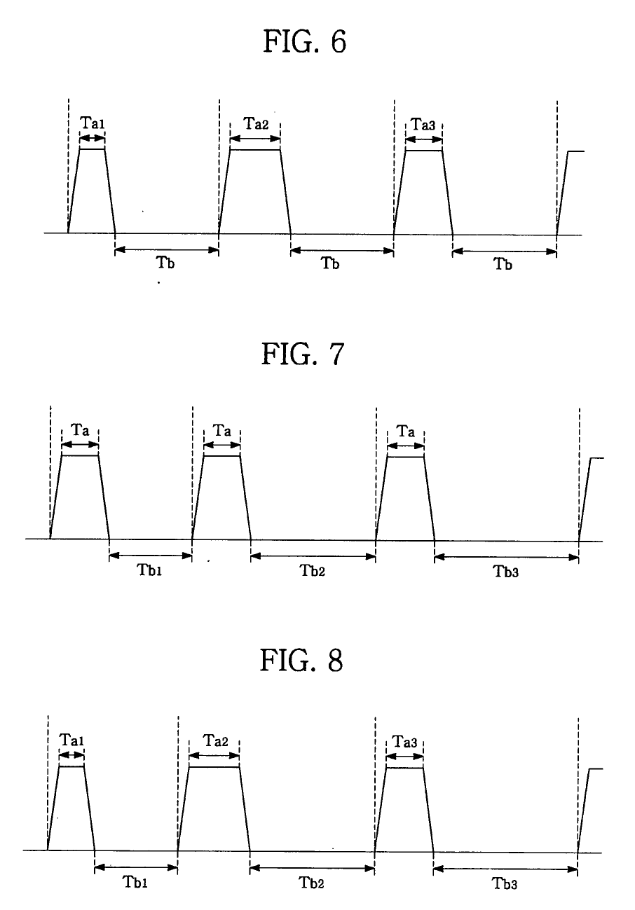

FIG. 6 is a drawing for an exemplary implementation of a waveform of a discharge sustain voltage applied to scan electrodes and sustain electrodes during a discharge sustain period. Referring to FIG. 6, in the discharge sustain voltage applied to the scan electrodes 112 and the sustain electrodes 114, the rising edge voltage maintaining intervals (Ta₁, Ta₂, Ta₃) are randomly varied within a predetermined range, while the falling edge voltage maintaining intervals (Tb) are all made to have the same time. In other words, a discharge sustain voltage is so generated as to make Ta₁≠Ta₂≠Ta₃. The time range for randomly varying the rising edge voltage maintaining intervals (Ta₁, Ta₂, Ta₃) is, e.g., ±0.05˜1 μs.

FIG. 7 is a drawing for another exemplary implementation of a waveform of a discharge sustain voltage applied to scan electrodes and sustain electrodes during a discharge sustain period.

Referring now to FIG. 7, in the discharge sustain voltage applied to the scan electrodes 112 and the sustain electrodes 114, the rising edge voltage maintaining intervals (Ta) are all made to have the same time, while the falling edge voltage maintaining intervals (Tb₁, Tb₂, Tb₃) are randomly varied within a predetermined range. In other words, a discharge sustain voltage is so generated as to make Tb₁≠Tb₂≠Tb₃. The time range for randomly varying the falling edge voltage maintaining intervals (Tb₁, Tb₂, Tb₃) is e.g., ±0.05˜1 μs as well.

FIG. 8 is a drawing for still another exemplary implementation of a waveform of a discharge sustain voltage applied to scan electrodes and sustain electrodes during a discharge sustain period.

Referring to FIG. 8, in the discharge sustain voltage applied to the scan electrodes 112 and the sustain electrodes 114, the rising edge voltage maintaining intervals (Ta₁, Ta₂, Ta₃) are randomly varied within a predetermined range, and the falling edge voltage maintaining intervals (Tb₁, Tb₂, Tb₃) are also randomly varied within a predetermined range. In other words, a discharge sustain voltage is so generated as to make Ta₁≠Ta₂≠Ta₃ and Tb₁≠Tb₂≠Tb₃. Even in this case, the time range for randomly varying the rising edge voltage maintaining intervals (Ta₁, Ta₂, Ta₃) and the falling edge voltage maintaining intervals (Tb₁, Tb₂, Tb₃) is, e.g., ±0.05˜1 μs.

In driving the PDP 100, as the rising edge voltage maintaining intervals (Ta₁, Ta₂, Ta₃) and the falling edge voltage maintaining intervals (Tb₁, Tb₂, Tb₃) of the discharge sustain voltage applied to the scan electrodes 112 and the sustain electrodes 114 are randomly varied, a peak component of noise caused by resonance generated by the PDP 100 can be alleviated to reduce the noise.

The particular implementations disclosed above are illustrative only, as the implementations may be modified and practiced in different but equivalent manners apparent to those skilled in the art having the benefit of the teachings herein. Furthermore, no limitations are intended to the details of construction or design herein shown, other than as described in the claims below. It is therefore evident that the particular implementations disclosed above may be altered or modified and all such variations are considered within the scope and spirit of the present description. Accordingly, the protection sought herein is as set forth in the claims below.

What is claimed is:

1. A method for driving a plasma display panel (PDP) comprising: applying a driving voltage to scan electrodes during an initialization period to initialize cells; applying a driving voltage to scan electrodes during address period and applying image data to address electrodes to generate a start discharge to the initialized cells; and applying a cycle-randomly-varied discharge sustain voltage to the scan electrodes and sustain electrodes during a discharge sustain period to sustain discharges of cells where the start discharge has been generated.

2. The method as claimed in claim 1, wherein the cycle of the randomly-varied discharge sustain voltage is randomly varied within a predetermined time range.

3. The method as claimed in claim 2, wherein the predetermined time range is ±0.05˜1 μs.

4. The method as claimed in claim 1, wherein the randomly-varied discharge sustain voltage is such that a rising edge voltage maintaining interval where the discharge sustain voltage rises and maintains during the rising edge is randomly varied.

5. The method as claimed in claim 1, wherein the randomly-varied discharge sustain voltage is such that a falling edge voltage maintaining interval where the discharge sustain voltage falls and maintains during the rising edge is randomly varied.

6. The method as claimed in claim 1, wherein the randomly-varied discharge sustain voltage is such that a rising edge voltage maintaining interval where the discharge sustain voltage rises and maintains during the rising edge and a falling edge voltage maintaining interval where the discharge sustain voltage falls and maintains during the rising edge are randomly varied.

7. An apparatus for driving a plasma display panel (PDP) comprising: a timing signal generator for generating a scan timing signal, a sustain timing signal and an address timing signal in response to control of a processor; a scan driver for generating a driving voltage in response to the scan timing signal and applying the driving voltage to scan electrodes; a sustain driver for generating a driving voltage in response to the sustain timing signal and applying the driving voltage to sustain electrodes; and an address driver for applying image data to address electrodes in response to the address timing signal, wherein the timing signal generator comprises: a first random timing signal generator for randomly varying a generation cycle of the scan timing signal during discharge sustain period; and a second random timing signal generator for randomly varying a generation cycle of the sustain timing signal during the discharge sustain period.

8. The apparatus as claimed in claim 7, wherein the first and second random timing signal generators randomly vary the generation cycle of the scan timing signal and the sustain timing signal within a predetermined time range.

9. The apparatus as claimed in claim 8, wherein the predetermined time range is ±0.05˜1 μs.

10. The apparatus as claimed in claim 7, wherein the first random timing signal generator generates a scan timing signal such that the rising edge voltage maintaining interval of a driving voltage generated by the scan driver is randomly varied.

11. The apparatus as claimed in claim 7, wherein the first random timing signal generator generates a scan timing signal such that the falling edge voltage maintaining interval of a driving voltage generated by the scan driver is randomly varied.

12. The apparatus as claimed in claim 7, wherein the first random timing signal generator generates a scan timing signal such that the rising edge voltage maintaining interval and the falling edge voltage maintaining interval of a driving voltage generated by the scan driver is randomly varied.

13. The apparatus as claimed in claim 7, wherein the second random timing signal generator generates a sustain timing signal such that the rising edge voltage maintaining interval of a driving voltage generated by the sustain driver is randomly varied.

14. The apparatus as claimed in claim 7, wherein the second random timing signal generator generates a sustain timing signal such that the falling edge voltage maintaining interval of a driving voltage generated by the sustain driver is randomly varied.

15. The apparatus as claimed in claim 7, wherein the second random timing signal generator generates a sustain timing signal such that the rising edge voltage maintaining interval and the falling edge voltage maintaining interval of a driving voltage generated by the sustain driver is randomly varied.
